(19) United States
(12) Patent Application Publication
(10) Pub. No.: US 2016/0119619 A1
(43) Pub. Date: Apr. 28, 2016

(54) METHOD AND APPARATUS FOR ENCODING INSTANTANEOUS DECODER REFRESH UNITS

(71) Applicant: ATI Technologies ULC, Markham (CA)

(72) Inventor: Ihab M.A. Amer, Stouffville (CA)

(73) Assignee: ATI TECHNOLOGIES ULC, Markham (CA)

(21) Appl. No.: 14/524,013

(22) Filed: Oct. 27, 2014

(51) Int. Cl. H04N 19/105; H04N 19/136; H04N 19/124; H04N 19/119; H04N 19/176

(52) U.S. Cl. CPC H04N 19/105; H04N 19/119; H04N 19/176; H04N 19/124; H04N 19/136

(57) ABSTRACT

Method and apparatus for encoding instantaneous decoder refresh (IDR) units are disclosed. The method includes partially encoding an IDR block as a non-IDR block, decoding the partially encoded IDF block to generate a reconstructed IDR block and fully encoding the reconstructed IDF block as an IDR block. In a first pass, an IDR unit is partially encoded (no entropy encoding) using regular encoding parameters of a non-IDR unit in the same picture. The partially-encoded IDR unit is then inverse quantized and inverse transformed to generate a reconstructed video data of the IDR unit. In the second pass, the reconstructed video data of the IDR unit is passed as an input to the prediction module and fully encoded using the IDR settings. The reconstructed IDR unit may be encoded with very high fidelity.

### BACKGROUND

Digital video processing capabilities are included in a wide range of digital devices, such as digital televisions, cellular wireless phones including smart phones, personal digital assistants (PDAs), laptop or desktop computers, tablet computers, digital cameras, digital recording devices, digital media players, video gaming devices, and the like. These devices frequently implement video compression techniques in accordance with standards such as Motion Picture Expert Group-2 (MPEG-2), MPEG-4, International Telecommunication Union-Telecommunication (ITU-T) H.263, ITU-T H.264, and the like. By compressing the source video data, the video data may be more efficiently processed and transferred.

While encoding digital video data, in order to allow potential random access of the video signal, as well as for error resiliency reasons (e.g., for the decoder to be able to recover if an access unit of the bit stream is corrupted), a few units (e.g., frames, fields, slices, macroblocks, or the like) may be encoded as an instantaneous decoder refresh (IDR) unit. An IDR unit is a special type of intra-predicted (I) unit. An IDR unit specifies that no picture after the IDR unit can reference any picture before it.

Typically, the IDR units come in patterns (e.g., once every preset number of frames and/or preset specific regions within a frame). When the IDR units come in preset specific regions within a frame, it may cause irritating repetitive patterns that harm the subjective quality of the video since the encoding process of an IDR unit results in a different quality (higher or lower quality) of reconstructed signal as compared to a non-IDR unit.

This may cause a significant impact on pattern-based intra refresh, for example, for wireless display (WD) and cloud gaming applications. Due to the low-latency requirement of these applications, inserting a complete IDR frame in the bit stream may not be practical since the IDR frames (which are also I frames) are typically less efficient (that is, compressed to a lesser amount) than P or B frames and generate a big spike in bit streams, which may cause additional delay in buffering at the decoding side. In order to prevent sudden boost in bit stream picture size, the IDR units may be scattered among a few successive frames. For example, a frame may be partitioned into multiple columns (or any other forms of partitions), and each column may be encoded as an IDR-type unit over a few successive frames. This may make such visual impact noticeable as users can see an IDR unit and a set of non-IDR units within the same frame or picture. The IDR units typically change their position from frame to frame in a predetermined pattern. This makes the users feel like something is rolling on the screen. Therefore, it would be desirable to provide a solution to remove or reduce such negative visual effects caused by the IDR units.

### SUMMARY

A method and apparatus for encoding instantaneous decoder refresh (IDR) units scattered over a few successive pictures are disclosed. The method for encoding IDR units includes partially encoding an IDR block as a non-IDR block, decoding the partially encoded IDF block to generate a reconstructed IDR block and fully encoding the reconstructed IDF block as an IDR block.

In an embodiment, the IDR units are encoded in two passes. In the first pass, an IDR unit is partially-encoded (no entropy encoding) using regular encoding parameters of a non-IDR unit in the same picture. The prediction, transform and quantization of the IDR unit in the first pass are performed using the regular encoding parameters applied to the neighboring non-IDR units in the same picture. The partially-encoded IDR unit is then inverse quantized and inverse transformed to generate a reconstructed video data of the IDR unit. In the second pass, the reconstructed video data of the IDR unit which results from the first pass is passed as an input to the prediction module and fully encoded using the IDR settings. In the second pass, the reconstructed IDR unit may be encoded with very high fidelity (e.g., very low quantization parameter for example, a quantization parameter of 0-10 for H.264 standard).

For encoding an IDR unit, prediction coding is performed on an IDR block as a non-IDR type to generate a first residual block. Transform coding is performed on the first residual block to generate first transform coefficients, and quantization is performed on the first transform coefficients. The quantized transform coefficients are inverse-quantized and inverse-transformed to generate a reconstructed IDR block. In the second pass, prediction coding is performed on the reconstructed IDR block as an IDR type to generate a second residual block. Transform coding is performed on the second residual block to generate second transform coefficients, and quantization is performed on the second transform coefficients. Entropy coding is performed on the second quantized transform coefficients, and the entropy coded transform coefficients are output as encoded video data of the IDR block. The reconstructed IDR block may be encoded with a high fidelity. For example, the second transform coefficients may be quantized using a low quantization parameter.

### BRIEF DESCRIPTION OF THE DRAWINGS

A more detailed understanding may be had from the following description, given by way of example in conjunction with the accompanying drawings wherein:

FIG. 1 is a block diagram of an example video encoder in accordance with one embodiment;

FIG. 2 is a flow diagram of an example process of encoding an IDR unit in accordance with one embodiment; and

FIG. 3 is a block diagram of an example video encoder in accordance with one embodiment.

### DETAILED DESCRIPTION

The embodiments will be described with reference to the drawing figures wherein like numerals represent like elements throughout.

Embodiments disclosed herein provide a way to avoid the adverse visual impact of IDR units' patterns that are scattered over a few successive pictures. In accordance with the embodiments, the appearance of visual patterns due to the usage of IDR units by a video encoder may be prevented while providing error resiliency and random access. The embodiments disclosed herein are applicable to both interlaced video and progressive video.

Each picture is partitioned into a plurality of portions and one portion in each picture is encoded as IDR type over a few successive pictures so that each picture includes a portion that is encoded as IDR type and other portions that are not encoded as IDR type. Hereafter, the terminology “IDR unit” refers to a portion of a picture that is encoded as an IDR type, and the IDR unit may be in any shape, (e.g., bar, row, column, etc.).

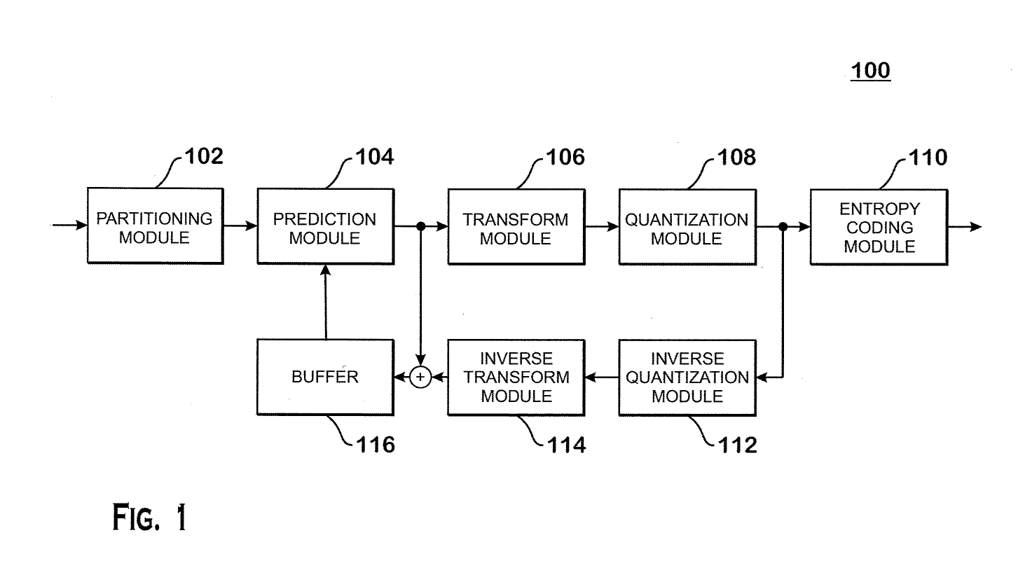

FIG. 1 is a block diagram of an example video encoder 100 in accordance with one embodiment. The video encoder 100 includes a partitioning module 102, a prediction module 104, a transform module 106, a quantization module 108, an entropy coding module 110, an inverse quantization module 112, an inverse transform module 114, and a buffer 116.

Input video data is partitioned into video blocks by the partitioning module 102. The partitioning may include slices, columns, tiles, macroblocks, blocks, or any other units.

The prediction module 104 compresses the source video data using spatial prediction (intra-prediction) and/or temporal prediction (inter-prediction) to reduce redundancy existing in the sequence of source video data. An intra-coded picture or slice of a picture (I picture or slice) is encoded using spatial prediction with respect to reference samples in neighboring blocks in the same picture. An inter-coded picture or slice of a picture (P or B picture or slice) is encoded using spatial prediction with respect to reference samples in neighboring blocks in the same picture and/or temporal prediction with respect to preceding or succeeding reference picture(s).

A predictive block generated by the prediction module 104 is subtracted from a source video block to generate a residual block. The output from the prediction module 104 is residual data (i.e., residual block) that represents the pixel differences between the original source video block to be coded and the predictive block. An inter-coded block is encoded according to a motion vector that points to a block of reference samples forming the predictive block, and the residual data indicating the difference between the coded block and the predictive block. An intra-coded block is encoded according to the prediction mode and the residual data.

The transform module 106 may transform the residual block that is output from the prediction module 104 from a pixel domain to a transform domain. Discrete cosine transform (DCT), integer transform, or the like may be used to reduce spatial correlation in the residual data.

The output from the transform module 106 is a block of transform coefficients. The quantization module 108 may quantize the transform coefficients. The degree of quantization may be modified by adjusting a quantization parameter. The quantized transform coefficients, initially arranged in a two-dimensional array, may be scanned in a zig-zag order to produce a one-dimensional vector of quantized transform coefficients.

The entropy coding module 110 performs entropy coding, such as context adaptive variable length coding, context adaptive binary arithmetic coding, or the like, on the quantized transform coefficients. The entropy coded bit streams 111 are output as encoded video data.

The inverse quantization module 112 performs inverse quantization on the quantized transform coefficients and the inverse transform module 114 performs inverse transform on the inverse quantized transform coefficients to reconstruct the residual block. The inverse quantization and the inverse transform are inverse of the processing performed in the quantization module 108 and the transform module 106, respectively. The reconstructed residual block is added to the predictive block to reconstruct the video block. The reconstructed video block is stored in the buffer 116 for later use as a reference block.

Non-IDR units are processed by the prediction module 104, the transform module 106, the quantization module 108, and the entropy coding module 110, and output as coded video data in a single pass.

IDR units (i.e., the blocks that belong to the IDR units) are encoded in two passes. In the first pass, an IDR unit is partially-encoded (no entropy encoding) using the regular encoding parameters of a non-IDR unit in the same picture. The IDR unit is encoded by the prediction module 104 to form a residual block, and the residual block of the IDR unit is transformed into a block of transform coefficients by the transform module 106, and the transform coefficients are quantized by the quantization module 108. The prediction, transform and quantization of the IDR unit in the first pass are performed using the regular encoding parameters applied to the neighboring non-IDR units in the same picture, (i.e., the IDR unit is coded as a non-IDR unit in the first pass). In an embodiment, at least the prediction module 104, the transform module 106 and the quantization module 108 may be collectively referred to as a partial encoding module. The partially-encoded IDR unit in the first pass is then processed to generate a reconstructed video data of the IDR unit. The quantized transform coefficients of the IDR unit are inverse quantized by the inverse quantization module 112, inverse transformed by the inverse transform module 114, and added to the associated predictive block to generate a reconstructed video data of the IDR unit. In an embodiment, at least the inverse quantization module 112 and the inverse transform module 114 may be referred to as a decoder module.

In the second pass, the reconstructed video data of the IDR unit that resulted from the first pass is passed as an input to the prediction module 104 and fully encoded using the IDR settings. The reconstructed IDR unit is encoded by the prediction module 104 to form a residual block as an IDR unit. The residual block is transformed into a block of transform coefficients by the transform module 106, and the transform coefficients are quantized by the quantization module 108. The quantized coefficients of the IDR unit are then entropy coded by the entropy coding module 100 and output as encoded video data of the IDR unit.

In one embodiment, in the second pass, the reconstructed IDR unit may be encoded with very high fidelity (e.g., very low quantization parameter, for example, quantization parameter of 0-10 for H.264 standard). The quantization parameter may be selected to ensure almost perfect second encoding phase that keeps the same quality generated in the first phase.

With this embodiment, the IDR units will still exist in the bit stream to provide error resiliency and random access, while there will be no clear visual patterns that correspond to the change of the encoding parameters in the IDR units.

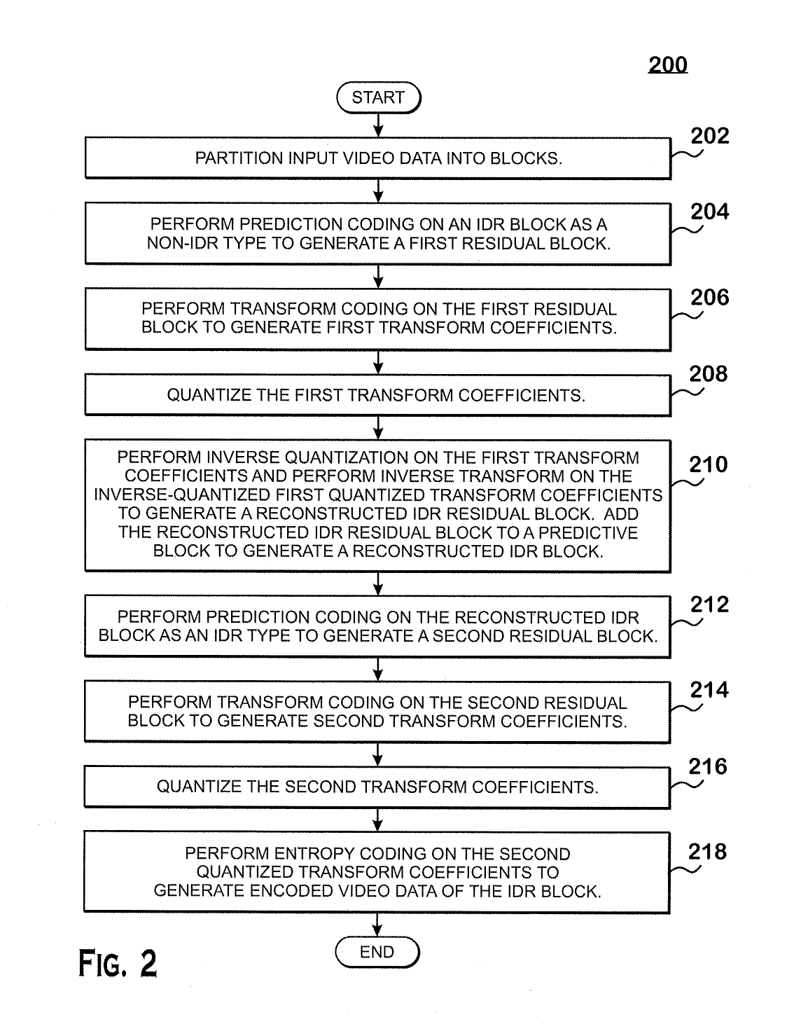

FIG. 2 is a flow diagram of an example process 200 of encoding an IDR unit in accordance with one embodiment. Input video data is partitioned into blocks (202). An IDR block is encoded using a two pass processing. Prediction coding is performed on an IDR block as a non-IDR type to generate a first residual block (204). Transform coding is then performed on the first residual block to generate first transform coefficients (206). The first transform coefficients are then quantized (208).

Inverse quantization is performed on the first transform coefficients and inverse transform is performed on the inverse-quantized first quantized transform coefficients to generate a reconstructed IDR residual block, and the reconstructed IDR residual block is added to a predictive block to generate a reconstructed IDR block (210).

In the second pass, the reconstructed IDR block is used as an input. Prediction coding is performed on the reconstructed IDR block as an IDR type to generate a second residual block (212). Transform coding is then performed on the second residual block to generate second transform coefficients (214). The second transform coefficients are then quantized, for example, using a very low quantization parameter (216). Entropy coding is then performed on the second quantized transform coefficients to generate encoded video data of the IDR block (218).

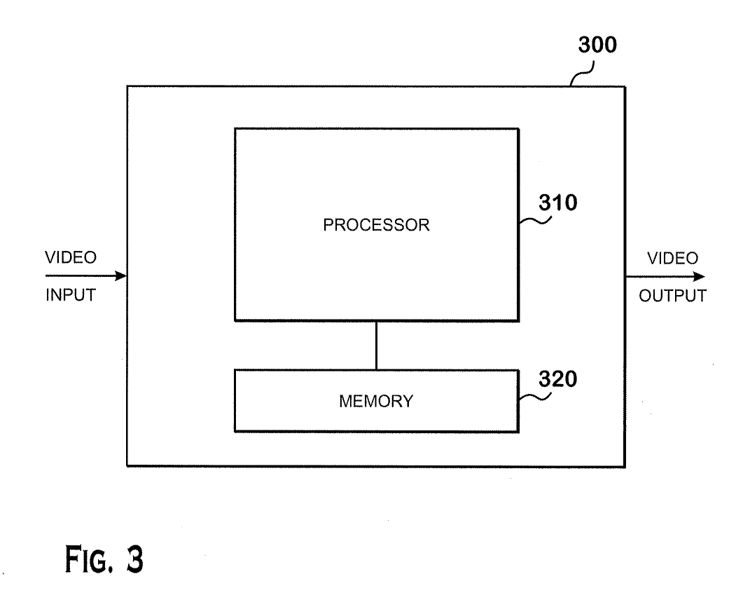

FIG. 3 is a block diagram of an example video encoder 300 in which one or more embodiments disclosed above may be implemented. The video encoder 300 may include a processor 310 and a memory 320. The processor 310 is configured to receive input video data and encode an IDR block using the two-pass processing as disclosed above. The processor 310 may be any processing component including, but not limited to, a central processing unit (CPU), a graphics processing unit (GPU), a fusion processor, one or more processor cores, wherein each processor core may be a CPU or a GPU, or the like. The memory 320 may be located on the same chip as the processor 310, or may be separate from the processor 310. The memory 320 may be any type of memories either volatile or non-volatile memory including, but not limited to, a random access memory (RAM), a cache, or the like. Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Embodiments of the present invention may be represented as instructions and data stored in a non-transitory computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

A non-transitory computer-readable storage medium may store a set of instructions for execution by a processor to encode IDR units. The set of instructions may comprise a code segment for performing prediction coding on an IDR block as a non-IDR type to generate a first residual block, a code segment for performing transform coding on the first residual block to generate first transform coefficients, a code segment for performing quantization on the first transform coefficients, a code segment for performing inverse quantization on the first quantized transform coefficients and performing inverse transform to generate a reconstructed IDR block, a code segment for performing prediction coding on the reconstructed IDR block as an IDR type to generate a second residual block, a code segment for performing transform coding on the second residual block to generate second transform coefficients, a code segment for performing quantization on the second transform coefficients, a code segment for performing entropy coding on the second quantized transform coefficients, and a code segment for outputting the entropy coded transform coefficients as encoded video data of the IDR block. The set of instructions may comprise a code segment for partitioning input video data of a picture into a plurality of partitions, wherein one partition of input video data is encoded as an IDR type over a plurality of consecutive pictures.

In general, a method for encoding instantaneous decoder refresh (IDR) units includes partially encoding an instantaneous decoder refresh (IDR) block as a non-IDR block, decoding the partially encoded IDF block to generate a reconstructed IDR block and fully encoding the reconstructed IDF block as an IDR block.

The partial encoding may include at least performing prediction coding on an instantaneous decoder refresh (IDR) block as a non-IDR type to generate a first residual block, performing transform coding on the first residual block to generate first transform coefficients, and performing quantization on the first transform coefficients.

The decoding the partially encoded IDF block to generate a reconstructed IDR block may include at least performing inverse quantization on the first quantized transform coefficients and performing inverse transform to generate a reconstructed IDR block.

The full encoding may include at least performing prediction coding on the reconstructed IDR block as an IDR type to generate a second residual block, performing transform coding on the second residual block to generate second transform coefficients, performing quantization on the second transform coefficients, performing entropy coding on the second quantized transform coefficients and outputting the entropy coded transform coefficients as encoded video data of the IDR block.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A method for encoding instantaneous decoder refresh (IDR) units, the method comprising:
partially encoding an IDR block as a non-IDR block;
decoding the partially encoded IDF block to generate a reconstructed IDR block; and
fully encoding the reconstructed IDF block as an IDR block.

2. The method of claim 1, wherein the reconstructed IDR block is encoded with a high fidelity.

3. The method of claim 2, wherein fully encoding the reconstructed IDF uses very low quantization parameters.

4. The method of claim 3, wherein the quantization parameters of 0-10 are used for International Telecommunication Union-Telecommunication (ITU-T) H.264 protocol.

5. The method of claim 1, further comprising:
partitioning input video data into a plurality of partitions, wherein one partition of input video data is encoded as an IDR type over a plurality of consecutive pictures.

6. The method of claim 5, wherein the input video data of one picture is partitioned into slices, columns, rows, tiles, macroblocks, or blocks.

7. The method of claim 1, wherein input video data is encoded in accordance with International Telecommunication Union-Telecommunication (ITU-T) H.264 protocol.

8. The method of claim 1, wherein partially encoding lacks entropy coding as performed in fully encoding.

9. A device for encoding instantaneous decoder refresh (IDR) units, comprising:
a video encoder configured to partially encode an IDR block as a non-IDR block;
the video encoder configured to decode the partially encoded IDF block to generate a reconstructed IDR block; and
the video encoder configured to fully encode the reconstructed IDF block as an IDR block.

10. The device of claim 9, wherein the reconstructed IDR block is encoded with a high fidelity.

11. The device of claim 9, wherein the video encoder uses a very low quantization parameter during fully encoding.

12. The device of claim 11, wherein the quantization parameter of 0-10 is used for H.264 standard.

13. The device of claim 9, further comprising:
a partitioning module configured to partition input video data of a picture into a plurality of partitions, wherein one partition of input video data is encoded as an IDR type over a plurality of consecutive pictures.

14. The device of claim 13, wherein the input video data of one picture is partitioned into slices, columns, rows, tiles, macroblocks, or blocks.

15. The device of claim 9, wherein input video data is encoded in accordance with International Telecommunication Union-Telecommunication (ITU-T) H.264 protocol.

16. The device of claim 9, wherein partially encoding lacks entropy coding as performed in fully encoding.

17. A non-transitory computer-readable storage medium storing a set of instructions for execution by a processor to encode instantaneous decoder refresh (IDR) units, the set of instructions comprising:
a code segment for performing partial encoding of an IDR block as a non-IDR block;
a code segment for performing decoding of the partially encoded IDF block to generate a reconstructed IDR block; and
a code segment for performing full encoding of the reconstructed IDF block as an IDR block.

18. The non-transitory computer-readable storage medium of claim 17, wherein the reconstructed IDR block is encoded with a high fidelity.

19. The non-transitory computer-readable storage medium of claim 17, wherein the full encoding of the reconstructed IDF block as an IDR block uses a very low quantization parameter.

20. The non-transitory computer-readable storage medium of claim 19, wherein the quantization parameter of 0-10 is used for H.264 standard.

21. The non-transitory computer-readable storage medium of claim 17, wherein the set of instructions may comprise:
a code segment for partitioning input video data of a picture into a plurality of partitions, wherein one partition of input video data is encoded as an IDR type over a plurality of consecutive pictures.

22. The non-transitory computer-readable storage medium of claim 17, wherein input video data is encoded in accordance with International Telecommunication Union-Telecommunication (ITU-T) H.264 protocol.

23. A method, comprising:
encoding an instantaneous decoder refresh (IDR) block as a non-IDR block absent entropy coding;
decoding the partially encoded IDF block to generate a reconstructed IDR block; and
encoding the reconstructed IDF block as an IDR block with entropy coding.

24. The method of claim 23, wherein the reconstructed IDR block is encoded with a high fidelity.
